(19) United States
(12) Patent Application Publication
(10) Pub. No.: US 2016/0269378 A1
(43) Pub. Date: Sep. 15, 2016

(54) First Artificial Intelligence Methods and Systems for Asset Trendspotting (PNN), Cyber Security (DeepCyber), and Portable Big Data Cloud (MCPS)

(71) Applicant: Gewei Ye, Timonium, MD (US)

(72) Inventor: Gewei Ye, Timonium, MD (US)

(21) Appl. No.: 14/658,156

(22) Filed: Mar. 14, 2015

(51) Int. Cl. H04L 29/06; G06N 3/08

(52) U.S. Cl. CPC H04L 63/08; G06N 3/08; H04L 63/1433; H04L 63/1425; H04L 63/1466

(57) ABSTRACT

New methods, systems, and apparatus, including computer programs called PNN (predictive neural network) artificial intelligence (AI) machines are disclosed for financial and cyber-security predictions. The PNN AI machines use unique neural network algorithms to optimize and select the best method with the highest back-test accuracy for the predictions. The PNN machines predict multiple relevant entities (e.g., stocks) to cross validate the future trends, and help respond to future financial and cyber-security crises like weather forecast to severe weather conditions. The PNN AI machines are applied in two fields: PNN Financial for investment and trading, and DeepCyber for cyber security. Extended from the PNN artificial neural networks (intelligence) machines, a group of DeepCyber methods based on the Mobile Cloud Pangu Servers (MCPS) cloud platform are disclosed to defend networks and computer applications for cyber security.

### 1.1 TECHNICAL FIELD OF THE INVENTION

### 1.1.1 PNN

A 2013 Nobel Laureate, Professor Shiller of Yale University has accurately predicted the 2000 Internet bubble burst and the 2008 stock market crash related to sub-prime mortgages. Could an investor acquire the ability of Professor Shiller to automatically and accurately predict long-term asset prices? Extending prior Nobel work with novel artificial neural-networks (intelligence) and sentiment algorithms, the PNN (predictive neural networks) machines are designed to help investors automatically predict securities prices, without sophisticated training in quantitative finance and computer science.

### 1.1.2 DeepCyber

Year 2014 saw the largest bank robbery ever (without the need for a getaway car): up to $900 million was stolen from JPMorgan Chase due to a massive cyber-attack. Experts found that an unsecured server on the bank's computer network was hacked. How to defend the unsecured server? DeepCyber solves the $900 million problem by inventing the first artificial intelligence (AI) cyber defense solution with deep learning algorithms. No other companies have yet developed such an AI solution.

### 1.1.3 MCPS

In response to the US DoD DARPA's specifications (i.e., specs) for the mobile cloud analytic environment, the detailed designs of mobile cloud on Pangu servers (MCPS) is proposed to fulfill the 18 specs at three cloud levels: IaaS (infrastructure as a service), PaaS (platform as a service), and SaaS (software as a service). The 18 DARPA specs as MCPS features are analyzed in Listing 1; each is associated with proposed enabling technologies and technical solutions from MCPS. A high-level design of MCPS is presented in Listing 2. A certification process (see Listing 3) is developed to accept hardware and software components for MCPS. Listing 4 shows how MCPS will meet the technical objectives to enable the mobile cloud capabilities.

### 1.2 SUMMARY

Different from prior arts and patents, PNN AI machines use unique neural-networks and sentiment algorithms to optimize and select the best method with the highest back-test accuracy for the predictions; to predict multiple relevant entities to cross validate the mega trends; and to help respond to future financial and cyber-security crises like weather forecast to severe weather conditions.

The PNN AI machines are applied in two fields: as PNN Financial for investment and trading, and as DeepCyber solutions based on the MCPS cloud platform for cyber security.

PNN Financial is designed as the first “Google of Trendspotting” for investors to confidently forecast long-term asset price movements (i.e., asset trendspotting). It is the first data science computer machine of artificial intelligence and deep learning for asset trendspotting.

Extending the PNN AI machines for cyber security, the DeepCyber methods include a series of innovative methods and software as a service (SaaS) cloud-based cyber security solutions, among them: 1) DeepCyber artificial intelligence deep learning cloud engines, including artificial neural network (ANN) cloud engine and automatic causal modeling (ACM) cloud engine; 2) DeepCyber TFA (two factor authentication) to defend password hacks; 3) DeepCyber Value at Risk (VaR) cloud engine with Big Data analytics. Mobile Cloud on Pangu Servers (MCPS) is the first integrated cloud platform of AWS+DropBox+Cloudera+SAS that is powerful, portable and interoperable for cyber defense, trendspotting, drones, data center, and Internet of things.

### 1.3 DESCRIPTION OF THE RELATED ART

### 1.3.1 PNN Financial

What is PNN Financial? PNN Financial is designed as the “Google of Trendspotting” for investors to accurately forecast long-term asset price movements (i.e., asset trendspotting). It is the first data science product of artificial intelligence and deep learning for asset trendspotting. A PNN equity chart comes with real-time back-testing accuracy percentage (normally about 90%) to show its confidence in the model predictions, which is based on testing the PNN artificial intelligence and sentiment algorithms against historical price data. PNN may process asset trendspotting requests within minutes for over 10,000 stocks, 1500 ETFs, and 1900 mutual funds, 24 by 7.

How does PNN Financial work? A customer selects a ticker on a Website from a mobile or desktop device. She then enters her email address and clicks “Send Data”. The PNN backend takes the request, automatically generates an artificial intelligence and sentiment model, back-tests the model and produces an accuracy percentage, predicts the long term asset prices, visualizes all the price values in a PNN chart, and emails the chart. Within minutes, a PNN trendspotting chart with back-testing accuracy shows up in the customer's inbox. PNN has an intuitive interface for customers, yet very sophisticated modeling and computing backend.

Who are PNN Financial's customers? Like everyone needs weather forecast, every investor needs accurate automatic asset trendspotting with PNN. Every fund manager should use PNN to show investors the scientific underpinnings of investment decisions.

Why do customers choose PNN Financial over competitors and why is PNN different? This is because it takes about two weeks for a competitor firm (e.g., hedge funds or private equity firms) to deliver an expensive forecasting report for one single asset. This could cost more than $8000 and the report may not even use advanced algorithms and real-time back-testing. PNN produces affordable forecasting reports (e.g., $500 each) for hundreds of assets within minutes, with real-time back-testing accuracies and unique artificial intelligence and sentiment algorithms.

What is out of PNN Financial's scope? PNN offers an investment research product of asset trendspotting given the data available. The trends may self-adjust with new data set as the artificial intelligence algorithm learns the new information. Hence, the investment strategies and decisions are out of PNN's scope. Investors and fund managers are responsible for the gains and losses of assets due to their investment strategies and decisions.

PNN is the flagship brand of DeepCyber Inc., a U.S. company that develops the first data science product to provide artificial intelligence Big Data cloud solutions for investors and fund managers on asset trendspotting. PNN targets at $600 M valuation in 5 years. It is actively searching for commission-based strategic partners to grow its sales to fund managers and investors.

PNN Financial is powered by MCPS (Mobile Cloud on Pangu Servers), a cloud data center solution that could value at $14 billion when its full potential capabilities would be realized. The MCPS cloud data center combines the state-of-art referential capabilities of infrastructure as a service (IaaS) like Amazon AWS cloud compute, cloud storage like DropBox, Big Data platform like Hadoop, and advanced analytics platform like SAS. MCPS cloud data center is portable (e.g., fit for a car or drone) and the capabilities are interoperable among themselves.

### 1.3.2 DeepCyber

What is DeepCyber? Derived from PNN AI machines, DeepCyber includes a series of U.S. military-grade software as a service (SaaS) cloud cyber security solutions, among them: 1) DeepCyber artificial intelligence deep learning cloud engines, including artificial neural network (ANN) cloud engine and automatic causal modeling (ACM) cloud engine; 2) DeepCyber TFA (two factor authentication) to defend password hacks; 3) DeepCyber Value at Risk (VaR) cloud engine with Big Data analytics; 4) DeepCyber Cyber Fault-tolerant Attack Recovery (CFAR) engine; 5) DeepCyber multi-zone (firewall) security architecture (MSA) to defend network intrusions. DeepCyber is designed for U.S. Department of Defense DARPA's specifications (DARPA-BAA-15-13 and DARPA-BAA-14-64) to defend the most sophisticated cyber-attacks in the world.

How does DeepCyber work? Imagine cyber-attacks as “missiles” launched to enterprise servers as “the spaceship.” DeepCyber's AI “radar” (i.e., VaR, ANN, and PNN) picks up the attack signals. PNN may predict the probability of the damage and trigger a “radar-guided shield” (e.g., TFA and X509). The “missiles” should “explode” when hitting the “shield”. If the “shield” would not hold off the “missiles”, hundreds of “camouflage servers” created by CFAR may protect the real servers by leading the “missiles” to fake targets. Hence DeepCyber is a unique “radar-guided shield and camouflage (RSC)” AI solution that is far more advanced than the “tank armors” of competitors.

Who are DeepCyber's customers? To be more intelligent and effective in defending enterprise servers and networks, every bank, every mission-critical information system, and every government agency needs the AI cyber defense solution as DeepCyber. Three large banks are currently considering signing contracts with DeepCyber worth millions of dollars each year.

Why do customers choose DeepCyber over competitors and why is DeepCyber different? This is because of DeepCyber's unique AI algorithms. They are built into ANN, ACM, and PNN that are part of DeepCyber's “Radar”, making DeepCyber more intelligent and effective than competitors.

DeepCyber Inc., a Delaware C-Corp company is the first artificial intelligence Big Data cloud solution for enterprise and government customers on cyber defense. DeepCyber partners with Amazon Web Services (AWS) on cloud computing and with Hortonworks on Big data. In order to jumpstart its growth, DeepCyber needs to expand the sales and service teams by actively searching for strategic partners.

1.3.3 MCPS What is MCPS? Mobile Cloud on Pangu Servers (MCPS) is the combined PaaS platform of AWS+DropBox+Cloudera+SAS that is powerful, portable and interoperable for Cyber Defense, Drones, Data Center, and Internet of Things

Listing 1 outlines the 18 MCPS features (for the 18 DARPA specs), enabling technologies, and the technical solutions to make the features possible.

Listing 1 - 18 DARPA specs and technical solutions

| | | Enabling | |
|---|---|---|---|
| MCPS features | | technology | High-level technical solutions by MCPS |
| 1. | Small, lightweight | MCPS IaaS | Pangu servers are small and lightweight servers that |
| | IaaS cloud | operating | could be either mini units (4 × 4 inches) or micro |
| | computing | system, small | units (nodes) of the size of a credit card. This |
| | environment to | and credit-card | reduces system size, weight, and power (SWaP) for |
| | provide 100-1000 | sized Pangu | critical tactical local operations. MCPS could |
| | fold increase in | servers | compose a number of mini or micro Pangu servers |
| | computing | | that are clustered and virtualized to offer a powerful |
| | capabilities (e.g., | | IaaS mobile cloud environment; which would be |
| | big data workload | | enabled by an IaaS operating system as a private |
| | of 100 TB per | | cloud. MCPS will include compute, storage, wireless |
| | hour) | | networking and security, load balancing etc. MCPS |
| | | | will enable an analytic SaaS ecosystem for sensors' |
| | | | big data workload. The 100-1000 fold increase in |
| | | | computing capability will come from up to 100 |
| | | | virtual cloud servers that can be created from the |
| | | | MCPS IaaS compute capability. |
| 2. | Distributed and | IaaS, Hadoop | The MCPS IaaS is capable of creating up to 100 |
| | high performance | and Spark for | virtual cloud servers to process big data workload of |
| | computing (HPC) | massively | 100 TB per hour. The Hadoop/Spark ecosystem of |
| | capabilities at 100 | parallel | Pangu servers supports MPP workload through |
| | TB per hour by up | processing | distributed computing and linear scaling. For |
| | to 100 virtual | (MPP) | example, with the up to 100 virtual servers clustered |
| | cloud servers | | by Hadoop and Spark for linear scaling, the |
| | | | workload capability of each server (e.g., 1 TB per |
| | | | hour per server) could be aggregated linearly (e.g., |
| | | | 100 virtual servers) to achieve the big data workload |
| | | | of 100 TB per hour. Our patent-pending |
| | | | IaaS/Hadoop clustering approach of Pangu servers |
| | | | has largely amplified the computing capacity of |
| | | | MCPS and produced exciting preliminary result of |
| | | | performance tests on an MCPS big data system. |
| 3. | Multi-layer cloud | Cloud security, | Cloud security such as X.509 certificates (e.g., for |
| | security | DoD cloud | secure access to virtual servers), IPsec, encryption, |
| | | security model | IAM (identity and access management) will be |
| | | (CSM) | designed at three cloud levels: IaaS, PaaS, and SaaS. |
| | | | As a result, major security requirements of FISMA, |
| | | | FedRAMP and DoD CSM would be honored. |
| 4. | Mobile cloud | Panguscloud for | MCPS Pangscloud offers a Dropbox-like clone for |
| | storage | cloud storage | military unit members to store data and files in a |
| | | | local private cloud. This enables unit members and |
| | | | sensors to upload/sync data. Members may contact |
| | | | each other with mobile devices through the mobile |
| | | | cloud storage. The cloud storage capability is |
| | | | enabled by the scalable mobile storage cloud of |
| | | | MCPS. |
| 5. | Big Data by | Hadoop, | Big data tools of distributed processing (e.g., |
| | distributed | Spark | Hadoop and Spark) are deployed on MCPS as the |
| | processing | | platform as a service (PaaS) of the mobile cloud |
| | | | environment. |
| 6. | Modeling and | W, R, Spark | The machine learning, modeling and analytic |
| | Advanced | | engines of MCPS PaaS will analyze the sensor data |
| | analytics for | | to detect motions, categorize threat levels and |
| | detection and | | predict future scenarios based on modeling sensors |
| | characterization | | data. |
| | of behaviors of | | |
| | entities and | | |
| | systems that emit | | |
| | RF signals. | | |
| 7. | Wireless sensor | Ultra-wideband | The RF capability of MCPS would be enabled by |
| | data for behavior | (UWB),Wireless | specific RF channels, a UWB adapter and a WAP. |
| | detection and | access point | The sensors of the MCPS cluster would collect data |
| | modeling using | (WAP), RF, | for MCPS servers that will process large amount of |
| | locally-sensed | wireless sensors, | sensor signals through locally-sensed radio |
| | radio frequency | MCPS | frequency, UWB, and WAP. |
| | (RF). | | |
| 8. | Require low- | Portable | Though regular power supply is good for MCPS, |
| | power supply | batteries and | Pangu servers of MCPS would also operate under |
| | | solar batteries | low-power supplies such as portable batteries and |
| | | | solar batteries; This would enable portable and |
| | | | flexible deployment of wireless sensors and MCPS |
| | | | cloud in urban and/or less-developed areas. An |
| | | | independent power source of portable USB batteries |
| | | | (800 MA/5 V) would power up several micro nodes |
| | | | of the MCPS cluster. |
| 9. | SaaS Ecosystem | Custom sensors, | Powered by the MCPS IaaS cloud, a large amount of |
| | of sensor-based | MCPS virtual | multi-tenant capabilities of SaaS use cases are |
| | applications with | servers | expected for MCPS to enable a big data SaaS |
| | various types of | | ecosystems. The SaaS ecosystems are designed to |
| | server operating | | host all possible military sensors that would collect |
| | systems; other | | data from all data sources such as GPS location, |
| | available data | | terrain and climate data. With the IaaS cloud, |
| | sources | | existing widely-used military sensors and servers of |
| | | | long-range RF could also be hosted in the IaaS |
| | | | compute nodes of MCPS. |
| 10. | Use case 1: | Motion sensors, | Powered by the MCPS IaaS cloud, MCPS servers |
| | motion detection | MCPS servers | should process up to 100 sensors' signals of motion |
| | as SaaS (software | | detection with a workload of up to 100 TB per hour; |
| | as a service) | | this may serve as automated guards and alerting |
| | | | system of situation awareness for enemy movements |
| | | | in local surrounding areas. |
| 11. | Use case 2: local | Weather | Weather sensors of MCPS would capture |
| | weather station as | sensors, MCPS | temperature, humidity, and pressure data and |
| | SaaS | servers | transmit to MCPS servers wirelessly for local cloud |
| | | | processing and predictions. This will be especially |
| | | | useful for less-developed operational areas where |
| | | | weather reports are not available or not accessible to |
| | | | the specific local area. |
| 12. | Use case 3: remote | Camera | In combat, camera sensors attached to firearms or |
| | video streaming | sensors, MCPS | helmets will transmit combat videos to local MCPS |
| | and picture | servers | servers for decision making, integration, and |
| | capture as SaaS | | analysis at local military units. In non-combat |
| | | | scenarios, camera sensors may capture surrounding |
| | | | images and transmit the data to MCPS wirelessly for |
| | | | local surveillance, machine learning and advanced |
| | | | analysis. |
| 13. | Use case 4: GPS | GPS sensors, | GPS sensors capture longitude and latitude data of |
| | tracking as SaaS | MCPS servers | current location for MCPS servers to process locally. |
| | | | This is especially helpful to understand the |
| | | | surrounding terrain locally. |
| 14. | Use case 5: | Panguscloud, | As a local DropBox-like clone, the mobile storage |
| | Panguscloud of | MCPS servers | cloud (Panguscloud) of MCPS offers a local private |
| | MCPS cloud | | storage cloud for unit members to share information |
| | storage enables | | (intelligence, files, documents, music, events etc.) |
| | unit members and | | within the unit that owns the MCPS cloud system. |
| | sensors to upload | | |
| | and share | | |
| | intelligence or | | |
| | even music files. | | |
| 15. | Demonstrate use | MCPS, WAP, | MCPS and special-purpose sensors may be powered |
| | within and across | Sensor, portable | by portable batteries. This makes MCPS fit well in |
| | small units and | batteries | small units and vehicles, including manned and |
| | vehicles, to | | unmanned aircraft. The IaaS, PaaS, and SaaS of a |
| | include manned | | portable MCPS big data ecosystem would support a |
| | and unmanned | | wide range of drones. |
| | aircraft. | | |
| 16. | Analyses should | MCPS, W, R, | The machine learning, modeling and advanced |
| | not be limited to | Spark | analytic engines of MCPS PaaS such as W, R, and |
| | simple frequency | | Spark would go far beyond simple frequency |
| | analysis but also | | analysis. The predictive analytics engine of MCPS |
| | take into account | | would analyze interactions between sensor data and |
| | interactions | | make immediate recommendations on situation |
| | between sensed | | awareness and actionable decision making. |
| | entities and within | | |
| | the environment | | |
| 17. | Urban | MCPS, MPP, | Being powerful, wireless, small, and lightweight, a |
| | environments | wireless | MCPS cluster and sensors can handle urban |
| | | | operational areas with expanded military |
| | | | capabilities. The MPP, RF, wireless capabilities of |
| | | | MCPS enable more military capabilities through |
| | | | connecting existing networks in urban areas. |
| 18. | Less-developed | MCPS, WAP, | With portable and solar batteries, MCPS servers and |
| | operational areas. | RF, portable | sensors will especially suit well less-developed |
| | | battery, solar | operational areas. For example, Internet and satellite |
| | | energy | communication may not be accessible in the less- |
| | | | developed areas. Thus the critically important local |
| | | | weather and terrain reports are not available to the |
| | | | tactical units. MCPS would deliver sensor-based |
| | | | weather and terrain reports for the tactical units in |
| | | | the local less-developed areas. |

Listing 2 (see FIG. 12) presents a high-level design for the MCPS architecture that puts together software and hardware components of a MCPS. The components inside the dotted rectangle may be deployed inside vehicles, aircrafts or drones. The components outside of the dotted rectangle will be deployed as sensors that will transmit intelligence and data wirelessly to the servers hosted in MCPS IaaS cloud.

Listing 3 demonstrates the technical feasibility by certifying the vendors and capabilities of the MCPS components. The certification process includes identification of MCPS hardware and software components and the deployment and integration of SaaS software on a MCPS IaaS cloud.

The certification for a component is completed after the component is deployed and operates successfully according to the DARPA specs, as part of the IaaS, PaaS, or SaaS components for the portable big data MCPS cloud.

Listing 3 - certification status of MCPS components

| MCPS | |
|---|---|
| components | MCPS certification status |
| Lightweight | Certified two vendors that manufacture Pangu hardware |
| server | parts (e.g., CPU, hard drive, and RAM) in mini (4 |
| hardware | by 4 inches) and micro (credit-card) size. We plan |
| | to document and disclose the specs of the Pangu |
| | servers (e.g., make and model of CPU, RAM, and |
| | storage) for the MCPS when Phase I option starts. |
| Portable | Certified batteries from two vendors to power up |
| batteries | the light-weight servers; seeking a vendor that |
| | can power up MCPS components with solar energy. |
| Operating | A Linux distribution is certified for the MCPS |
| system | IaaS cloud operating system |
| IaaS software | An IaaS cloud operating system is certified as |
| to enable | IaaS enabler for the portable MCPS cloud cluster. |
| mobile cloud | Virtual servers are launched by the MCPS IaaS cloud |
| computing | that has been installed on the mini server. We plan |
| of a MCPS | to document and disclose specs of the certified |
| cluster | IaaS software when Phase I option starts. |
| Mobile cloud | Demo of MCPS's Panguscloud (certified as the |
| storage of a | mobile storage cloud) could be arranged at the end |
| MCPS cluster | of Phase I option period. |
| Ultra- | Several UWB and WAP device vendors are being |
| wideband | tested to be certified for MCPS. |
| (UWB) and | |
| WAP devices | |
| Motion | A vendor has been tested with MCPS and the sensor |
| sensors | works to alert operators when motion is detected. |
| Weather | A vendor is certified; weather sensor data stream is |
| sensors | transmitted to a MCPS server. |
| Camera | A vendor is certified; image data stream is transmitted |
| sensors | to a MCPS server. |
| GPS | A vendor is certified; GPS data stream is transmitted |
| sensors | to a MCPS server. |
| R | Vendor is certified as the modeling PaaS of MCPS |
| W | Vendor is certified as the machine learning and modeling |
| | PaaS of MCPS. W is an internal identifier of MCPS. It |
| | has very rich advanced analytics capabilities, especially |
| | for the hardware/software interface capabilities with |
| | sensors that R cannot achieve. We plan to document and |
| | disclose specs of W when Phase I option starts. |
| Hadoop | Apache Hadoop is certified and accepted as a MCPS |
| on | PaaS; Native Hadoop is installed on MCPS virtual |
| IaaS | servers (since Cloudera and Hortonworks Hadoops |
| | are NOT light-weight); MCPS benchmark and |
| | performance tests for workload of 100 TB per hour |
| | are in progress. |
| Spark | Apache Spark is being installed on the MCPS virtual |
| | servers. Spark will be 100-fold faster than Hadoop in |
| | memory. Initially we plan to run performance tests on the |
| | Hadoop cluster to meet DARPA's spec of 100 |
| | TB/hr in computational distribution. Then we plan |
| | to evaluate Spark cluster of MCPS after testing |
| | the performance of Hadoop cluster on MCPS. |
| USPTO | The new designs and systems of MCPS for the 18 |
| patent | DARPA specs will be documented in a USPTO patent |
| | application during the Phase I option period. Invention |
| | reporting to DARPA could happen afterwards. |

Furthermore, Listing 4 shows the links between the MCPS features (for the 18 DARPA specs) and the expected mobile cloud capabilities of MCPS.

Listing 4 - How will MCPS enable mobile cloud capabilities for the local military units?

| MCPS Mobile Cloud capabilities | How will MCPS enable the capabilities? |
|---|---|
| 1. Understand their own performance in | The MCPS SaaS and big data ecosystem for the |
| real-time by collecting and analyzing | sensors and sensor servers will enable the |
| the large amounts of blue force | understanding of the performance of tactical units in |
| information that is currently available, | real time. The SaaS ecosystem is highly adaptable to |
| but is largely discarded because the | all kinds of military use cases because the IaaS cloud |
| data is too large to transmit to an | enables the cloud compute capability for all the use |
| enterprise cloud facility and there is no | cases. In addition, the MCPS IaaS cloud is linearly |
| current ability to locally process the | scalable for massively-parallel-processing the data |
| data. | locally from all current or future sensors for the local |
| | military units. |
| 2. Understand red force behavior by | The red force behavior and nearby enemy information |
| locally collecting and analyzing nearby | will be collected and locally analyzed by the MCPS |
| enemy information | big data SaaS ecosystem. For example, the motion |
| | detection sensors and other sensors of MCPS would |
| | collect the data and then send the data to MCPS |
| | servers for real-time analysis locally for alerting, |
| | monitoring, or actions. Another example: the camera |
| | video streaming sensors of MCPS would perform |
| | combat recording to help local unit commanders to |
| | understand and integrate red force behavior and |
| | nearby enemy information for locally coordinated |
| | strategies and actions. |
| 3. Understand the environment by | The MCPS big data ecosystem would achieve this. For |
| collecting and analyzing information | example, the GPS sensors of MCPS SaaS ecosystem |
| about the surrounding terrain | would collect real-time data locally about the |
| | surrounding terrain. The machine learning, modeling |
| | and advanced analytics engines of MCPS servers (e.g., |
| | Spark, R and W) would analyze the data for |
| | intelligence and predictions. Another example: the |
| | weather sensor of a local MCPS would collect local |
| | weather data for analysis and predictions by the MCPS |
| | W servers. This is especially helpful for local-unit |
| | operations in less-developed areas where local weather |
| | data is not available or not accessible. |

### BRIEF DESCRIPTION OF THE DRAWINGS

FIG. 1—Intuitive User Interface for PNN Financial on Mobile or Web: investors or traders may use the Web interface to request PNN charts to be generated.

FIG. 2—Sample PNN monthly chart: the chart shows the highest back-test accuracy of more than ten algorithms; among them are four Nobel algorithms: 1) the Black-Scholes model on option pricing; 2) the Kahneman model on loss aversion; 3) the Engle model on GARCH volatility; 4) the Shiller/Fama models on financial trendspotting.

FIG. 3—Compare PNN Financial to Nobel-Prize work of Manual Empirical Trendspotting: this comparison shows that PNN Financial stands on giants shoulders and largely extends the capability of prior Nobel works; thus the comparison exhibits the significant difference for PNN Financial from prior art and patents.

FIG. 4—Formula to calculate real-time back-test accuracy from an asset's historical data: this validation method is new and different from prior arts or patents.

FIG. 5—Compare PNN Financial to Bloomberg and Kensho: PNN Financial charts provide the unique predicting capability by using the novel artificial neural networks and sentiment algorithms. This is the new capability that similar Bloomberg and Kensho systems cannot offer.

FIG. 6—PNN Valuation Approach: this shows the valuation calculation for PNN Financial based on referential capabilities of similar cloud and analytics systems.

FIG. 7—Technical Architecture of PNN machine: this shows the distributed computer systems of claim 1 that produce the PNN charts for investors. The functions and relationships of the computer systems are also presented in the technical system architecture.

FIG. 8—Compare PNN Models and Algorithms: this shows several sample algorithms for the PNN AI machines; along with four other Nobel models, the best prediction result is optimized and selected as shown on the PNN charts with the highest back-test accuracy for the prediction.

FIG. 9—Sample Diagram of Artificial Neural Networks: this shows the nodes of an artificial neural network that forms the core algorithms of the PNN AI machines.

FIG. 10—MCPS powered DeepCyber CFAR Architecture: this is the system architecture for cyber fault-tolerant attack recovery that is powered by the mobile cloud pangu server (MCPS); the MCPS also powers the PNN AI machines.

FIG. 11—MCPS Valuation: this shows how MCPS is valued by adding the values of the MCPS components that are similar to the popular referential capabilities.

FIG. 12—MCPS Architecture for 18 DARPA Specifications: this shows the MCPS-based system design for solving the 18 problems from the DARPA specifications.

FIG. 13—MCPS Web User Interface: this shows the Web portal interface for MCPS that is flexible to add or remove system components.

FIG. 14—MCPS Infrastructure as a Service (IaaS) Cloud: this shows the virtual components of an IaaS cloud that contains four virtualized servers on a virtualized network.

FIG. 15—MCPS Hadoop Big Data Platform: this shows that the native Hadoop cluster platform is ported on the MCPS cloud servers.

FIG. 16—MCPS Spark Platform: this shows that a native Spark platform is ported on the MCPS cloud servers

FIG. 17—MCPS Value at Risk (VaR) Design: this presents the architectural components of MCPS cloud servers for a VaR risk management system

FIG. 18—Quantify Cyber Risk with VaR Model: this shows sample code and result to quantify cyber risk based on the financial VaR algorithm

FIG. 19—Sample MCPS Automatic Causal Modeling: this shows the sample code and result of a causal modeling to uncover latent cyber risk causes by the MCPS cloud platform

FIG. 20—Sample MCPS Machine Learning on W and Hadoop: this shows the interface and steps to back test a time-series model and to conduct a study of structural equation modeling on MCPS servers

FIG. 21—MCPS Yoda of Machine Learning: this shows a supervised machine learning example to predict stock market crashes

FIG. 22—MCPS Solutions: this outlines the three designs of MCPS solutions for cyber risk modeling and analysis with latent variables

FIG. 23—MCPS VaR Solution: this shows the Value at Risk solution based on financial risk models and Big Data platforms on the MCPS servers

FIG. 24—Code of MCPS VaR Solution: this shows the core source code to implement the VaR algorithm in R

FIG. 25—Compare MCPS VaR to Financial VaR Models: this shows the difference to calculate cyber risk with VaR models from that of the financial risk

FIG. 26—MCPS VaR Enterprise Solution Design: this shows the reference system architecture to implement VaR models for assessing cyber risks

FIG. 27—MCPS VaR Enterprise Solution Backend: this shows the backend code to compute cyber risks with the VaR formula

FIG. 28—MCPS VaR Web Solution: this shows the system architecture of designing the Web user interface for the MCPS-based VaR engine

FIG. 29—MCPS VaR Web Demo: this shows the steps to create an—MCPS-based cyber-risk VaR chart based on the data input from the Web

FIG. 30—MCPS ACM Solution: this shows the system design of using—MCPS-based systems and automated causal modeling to assess and uncover the root causes of cyber risks

FIG. 31—MCPS ACM Web Engine: this shows the Web-based system design of the automated causal modeling system that uses structural equation modeling on the—MCPS cloud servers

FIG. 32—MCPS ACM Web Demo: this shows the source code and result of implementing an example of structural equation modeling

FIG. 33—MCPS Artificial Neural Networks: this shows the purpose and sample chart of generating an artificial neural network for uncovering latent causal relationships.

FIG. 34—MCPS Artificial Neural Networks for Forex: this shows an example of using artificial neural networks to uncover relationships between foreign exchange rates

FIG. 35—Design of MCPS Predictive Neural Networks: this shows the system architecture to generate PNN charts for user requests, along with a sample PNN chart for CVX (Chevron Corporation): a large U.S. oil company

FIG. 36—Design of MCPS CFAR: this shows the system architecture of an MCPS-based cyber security system to defend network applications with advanced data science analytics

FIG. 37—Detailed Design of MCPS CFAR: this shows the system design of an MCPS-based applications cyber defense system to provide the cyber fault-tolerant attack recovery capability

FIG. 38—DeepCyber Architecture powered by MCPS: this shows the high-level multi-zone security system architecture of an end-to-end MCPS-based cyber defense system that uses artificial neural networks (intelligence) to predict and attenuate cyber attacks

What is claimed is:

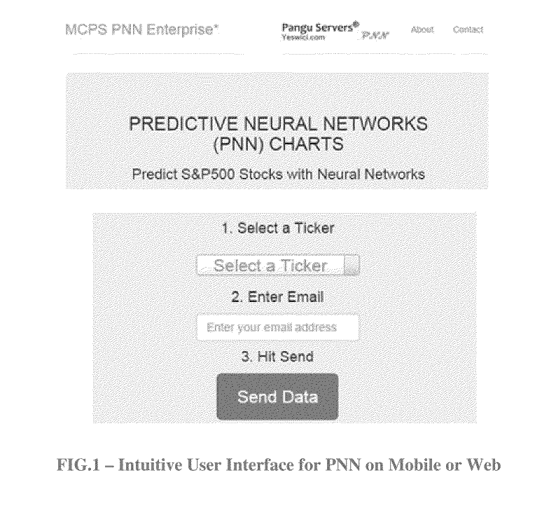

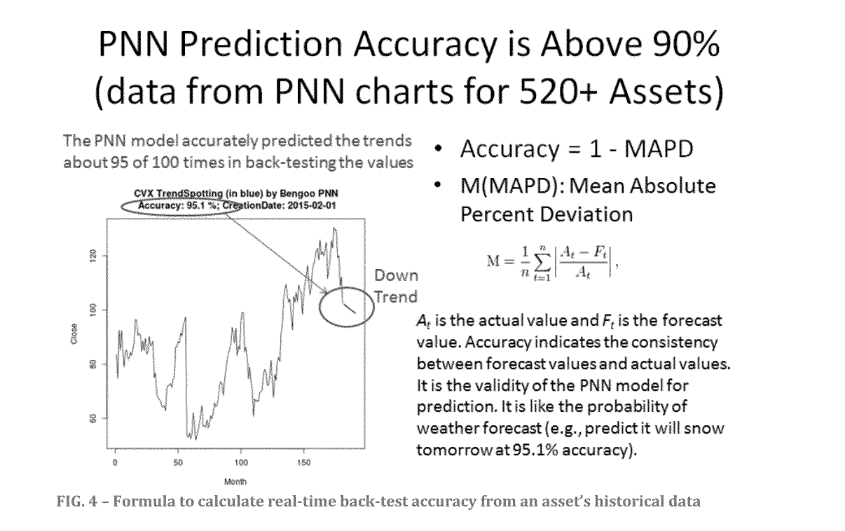

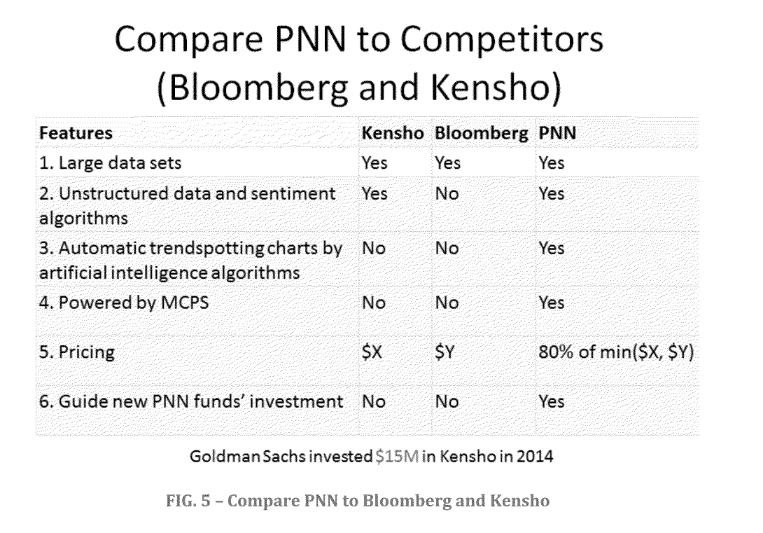

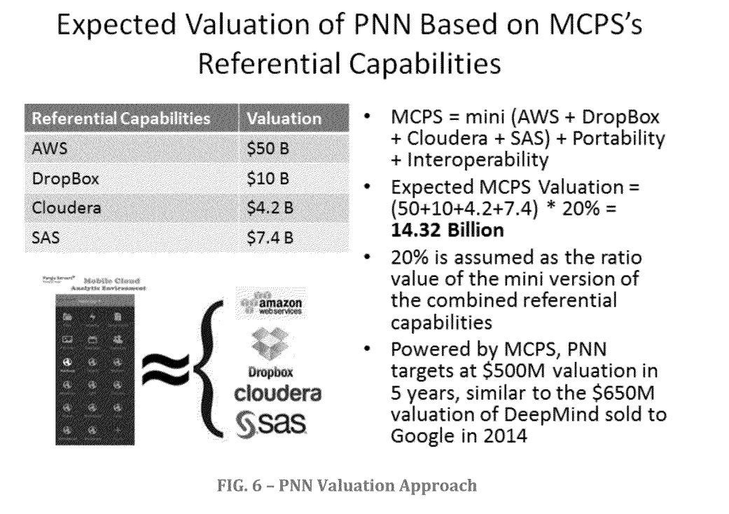

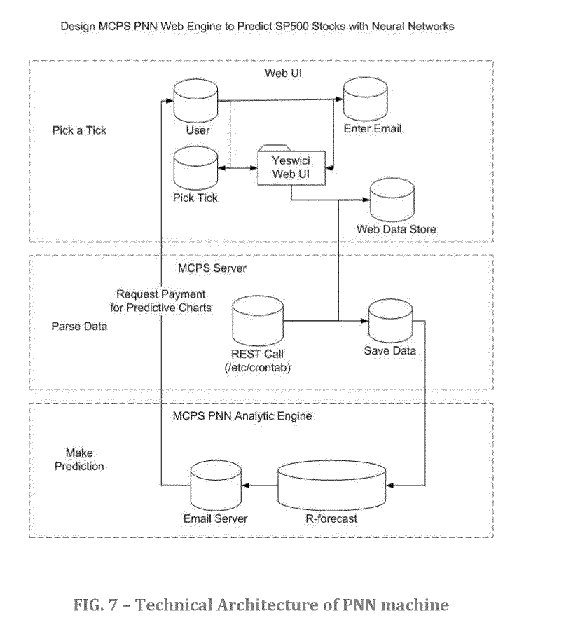

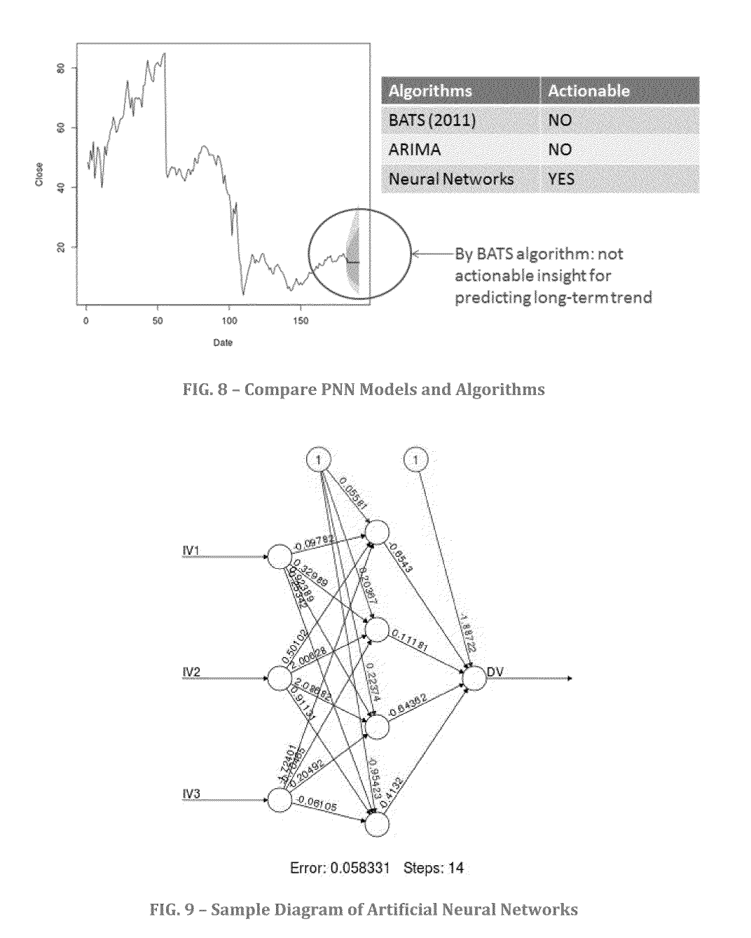

1. A group of computer-implemented systems called the PNN (Predictive Neural Networks) AI machines comprising:
distributed computers that provide intuitive Web user interfaces (see FIG. 1);
distributed computers that execute the PNN algorithms to optimize and select the best result with the highest back-test accuracy (see FIG. 4,7);
computer programs that implemented artificial neural networks and sentiment algorithms (see FIG. 4,7,9);

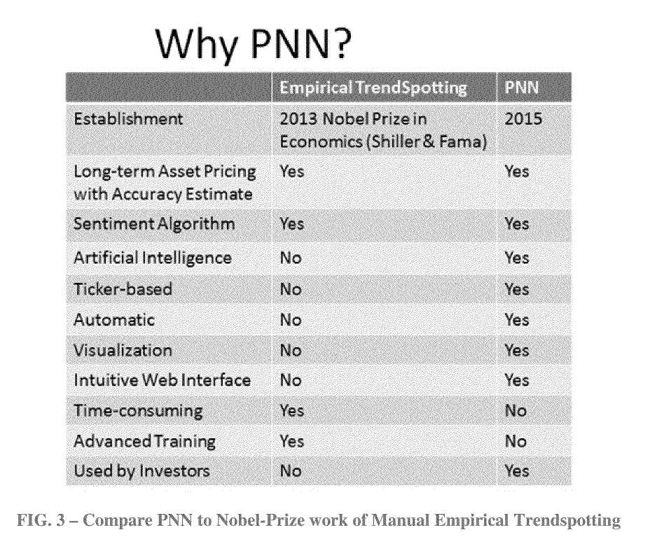

2. the first data science computer system of artificial neural networks and deep learning for financial predictions (see FIG. 3);

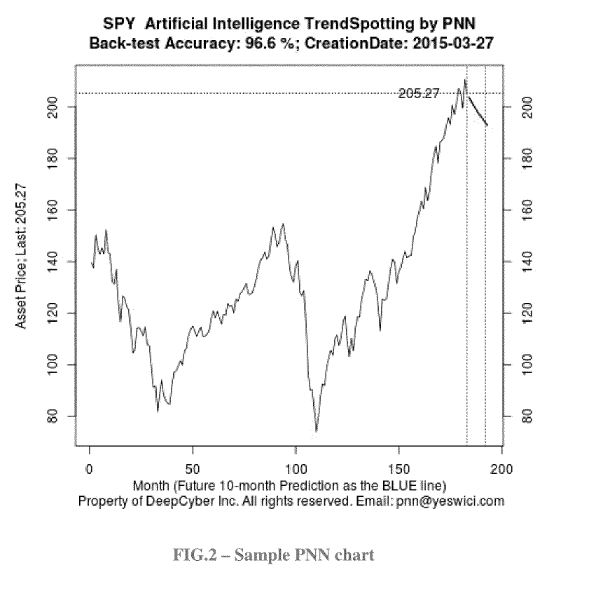

3. PNN Financial charts that are produced from the systems of claim 1 (see FIG. 2).

4. back-test accuracy validation method for the PNN charts: the real-time high back-testing accuracy percentages show the validities of the PNN machines in the financial predictions, which is based on testing the PNN artificial neural networks (intelligence) and sentiment algorithms against historical price data (see FIG. 4);

5. systems of claim 1 that process financial prediction requests within minutes for over 10,000 stocks, 1500 ETFs (Exchange-traded Funds), and 1900 mutual funds, 24 by 7 (FIG. 2);

6. methods of cross-validating financial prediction results with multiple relevant securities (e.g., SCO and UCO for oil industry) and creating very high back-test accuracies based on the artificial neural-networks algorithms (see FIG. 2, 8).

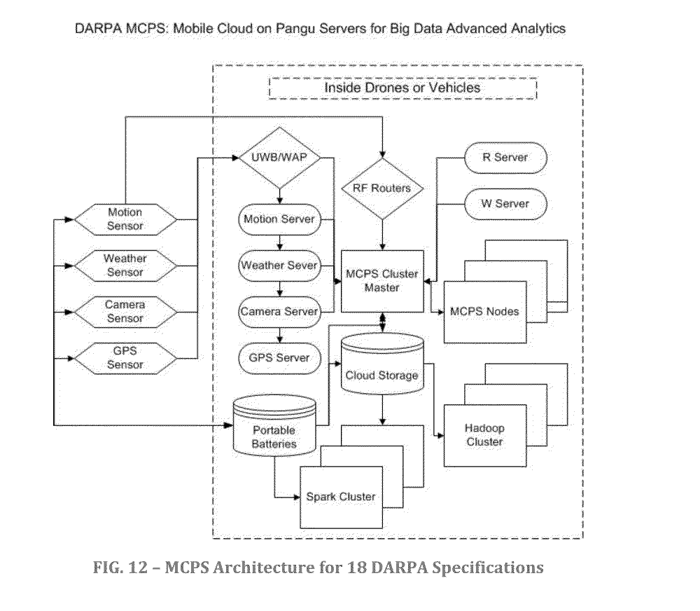

7. systems that power PNN Financial on the MCPS (Mobile Cloud on Pangu Servers) cloud platform (see FIG. 12).

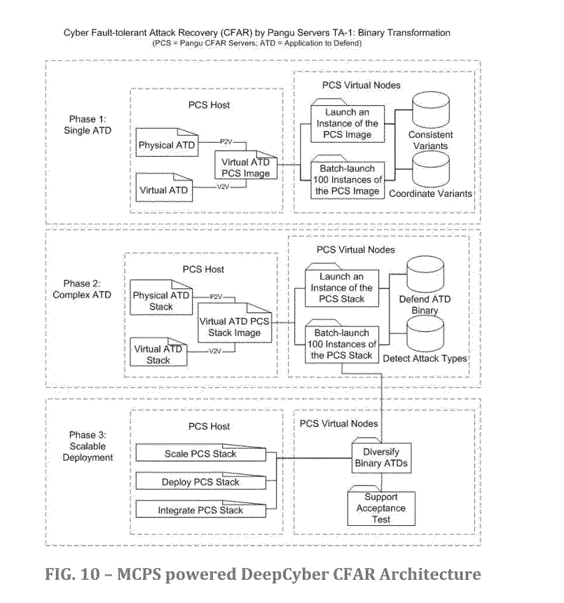

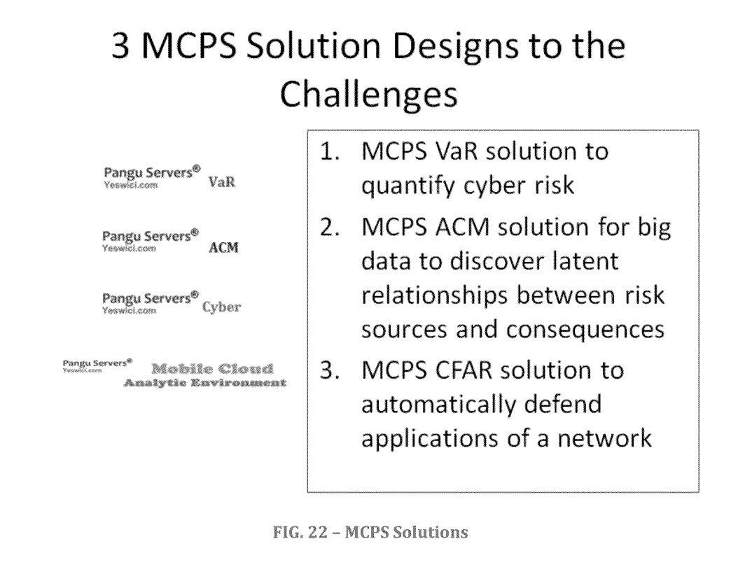

8. A group of computer-implemented methods called the MCPS and DeepCyber solutions comprising:
novel artificial neural-networks (intelligence) methods and systems called DeepCyber on the MCPS (Mobile Cloud on Pangu Servers) cloud (see FIG. 10);
MCPS-based DeepCyber artificial intelligence solutions: a series of U.S. military-grade software as a service (SaaS) cloud-based cyber-security solutions (see FIG. 22);

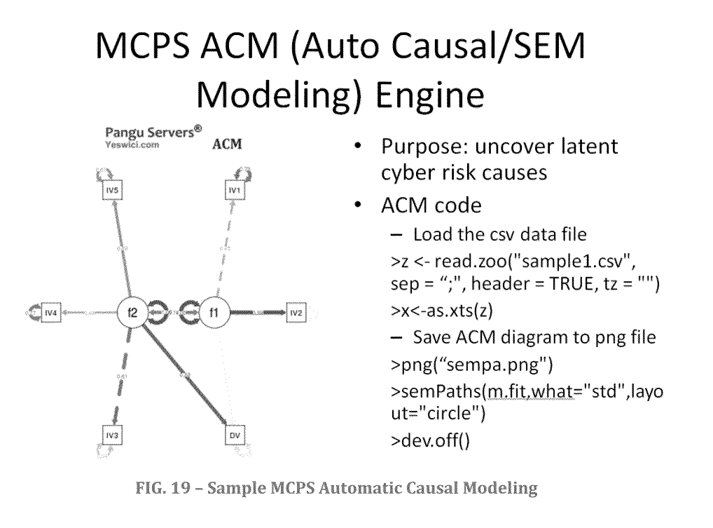

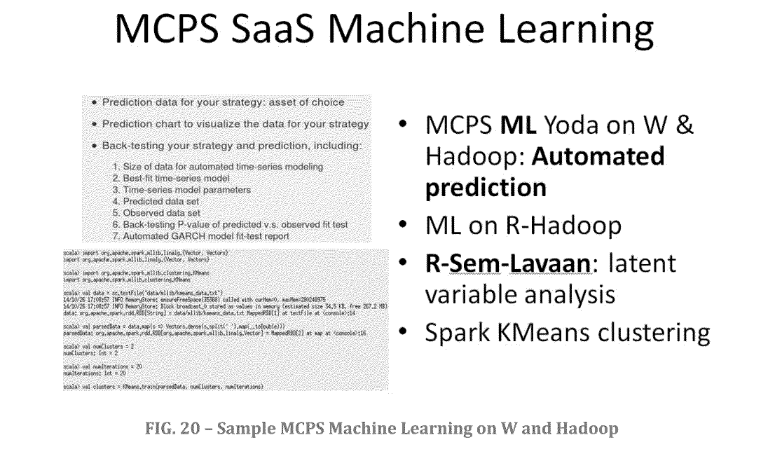

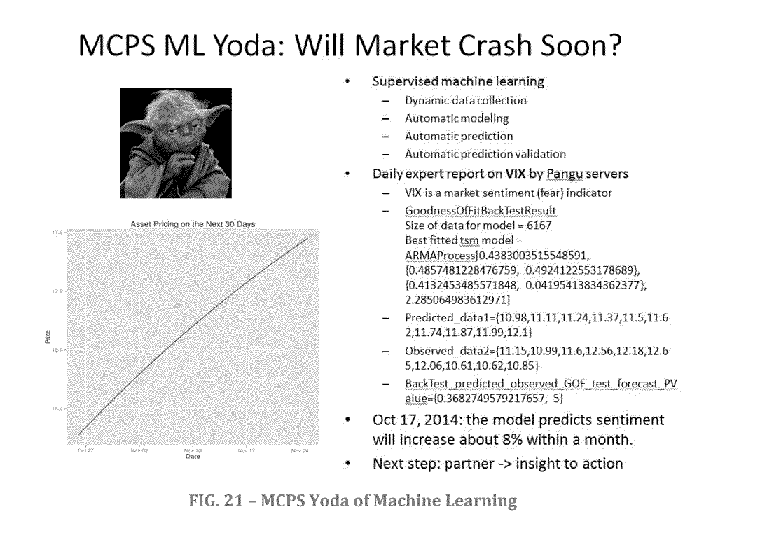

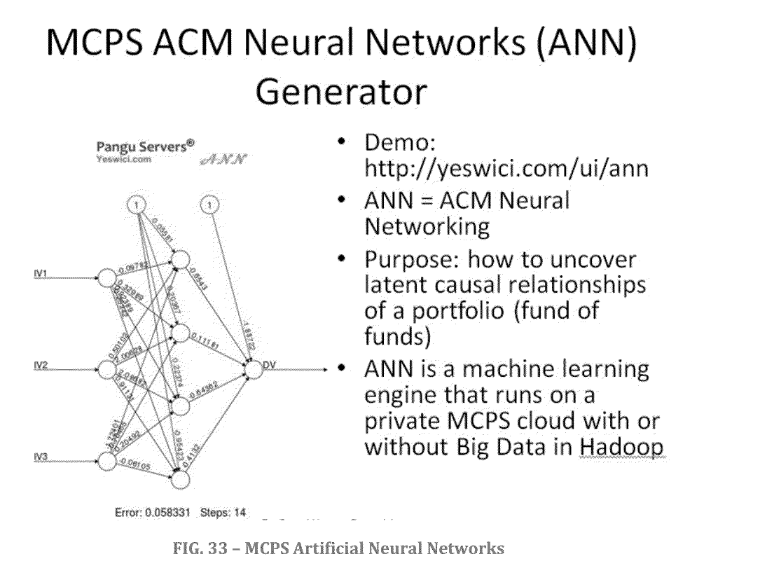

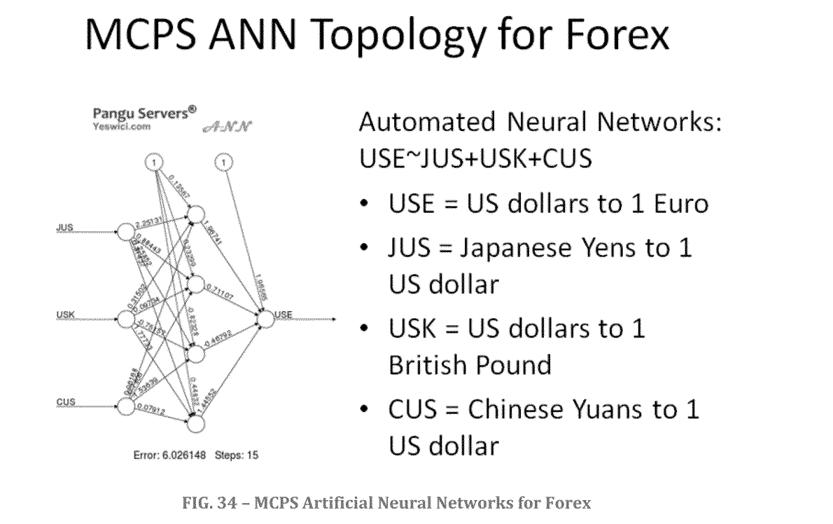

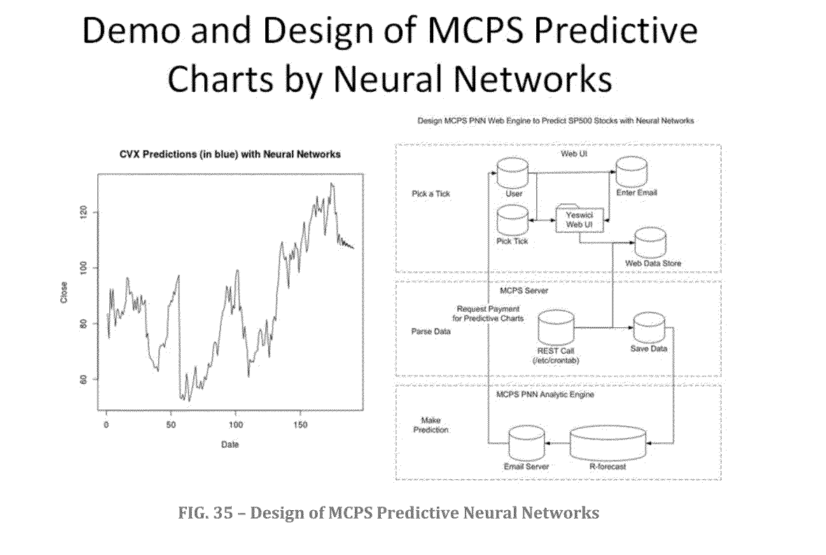

9. DeepCyber artificial-intelligence and deep-learning cloud-based engines, including the first artificial neural-networks (ANN) cloud engine (see FIG. 33) and the automatic causal modeling (ACM) cloud engines (see FIG. 9 and FIG. 19);

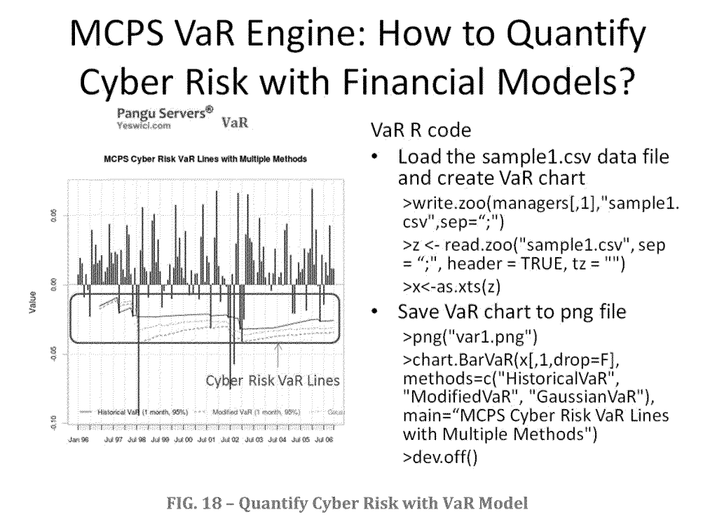

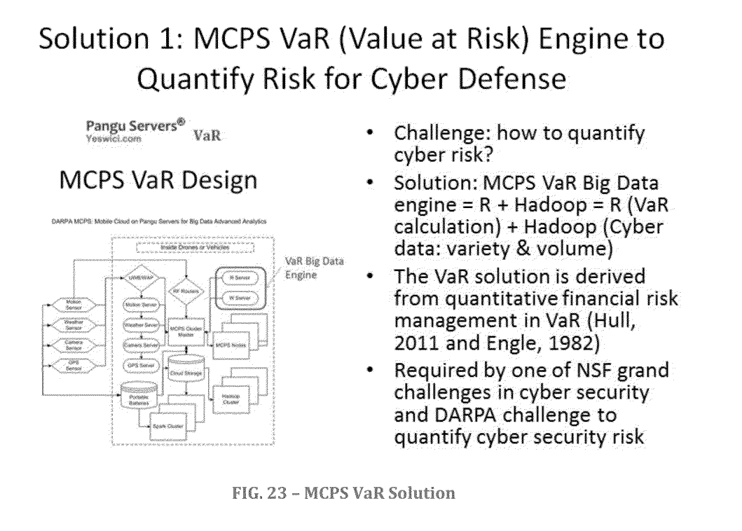

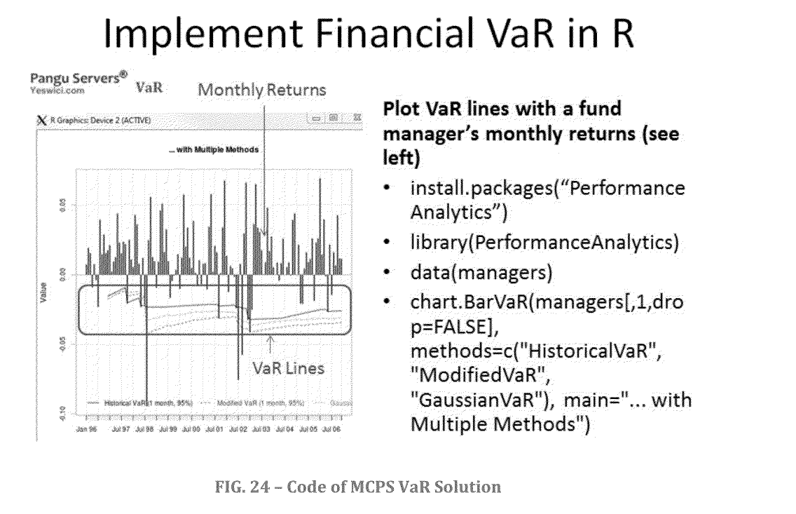

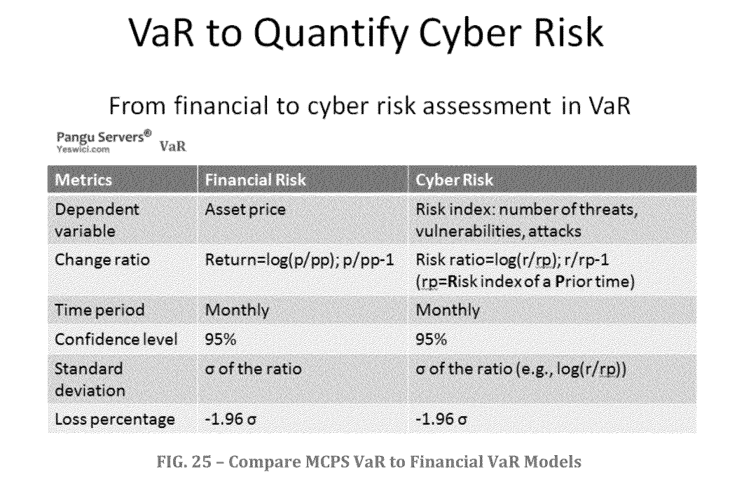

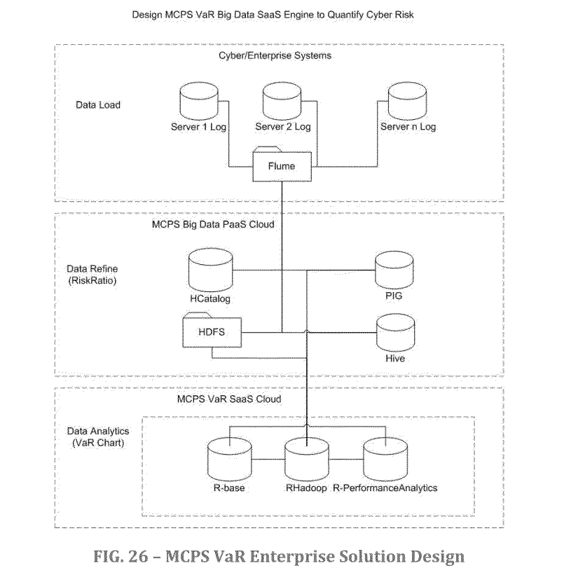

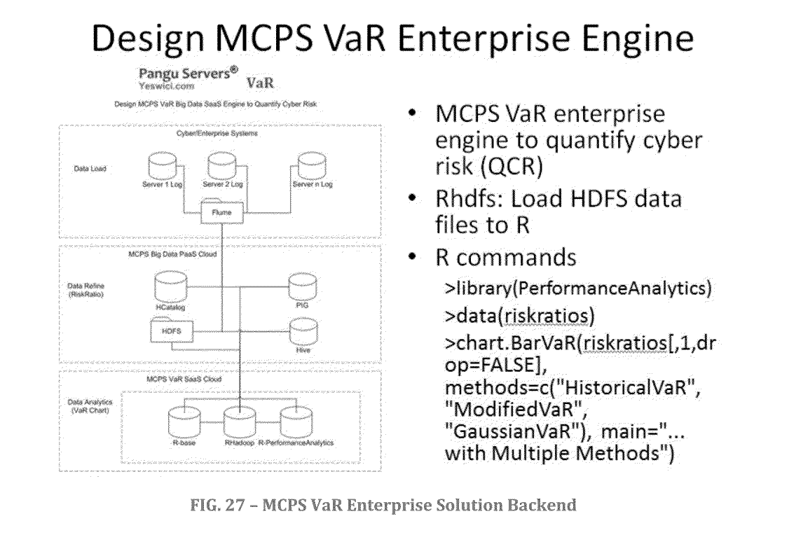

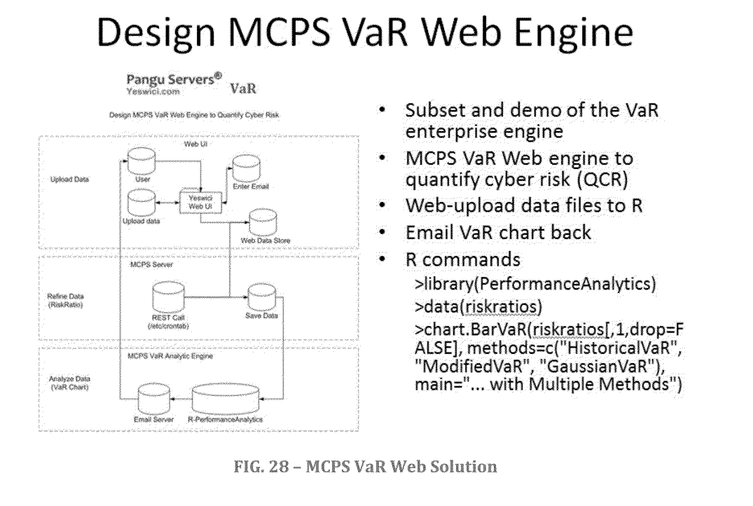

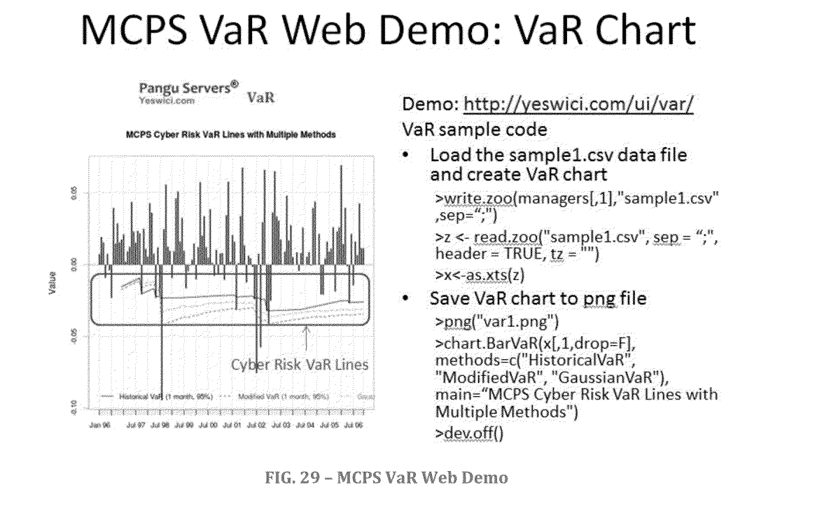

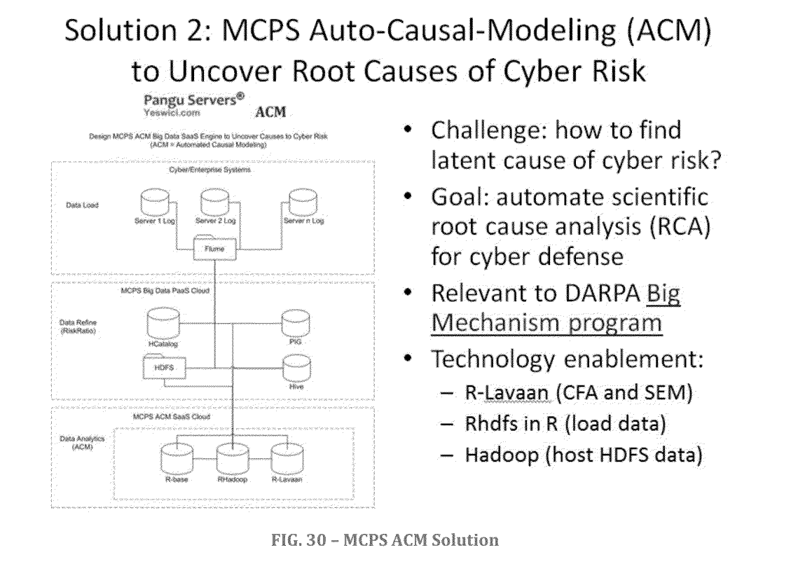

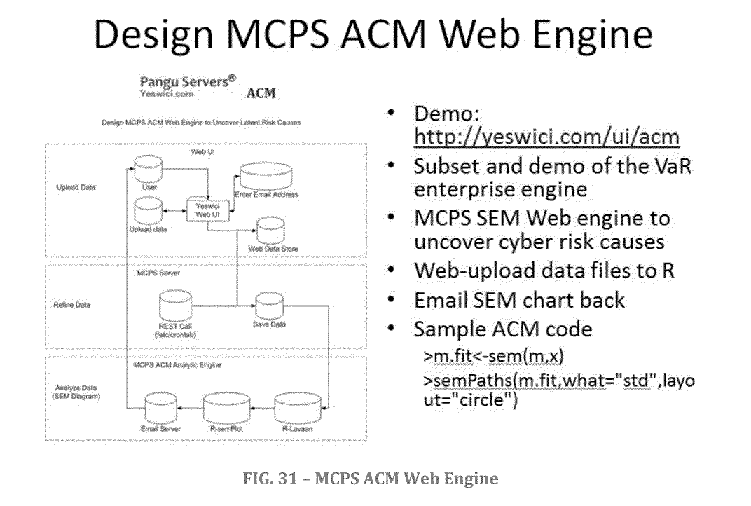

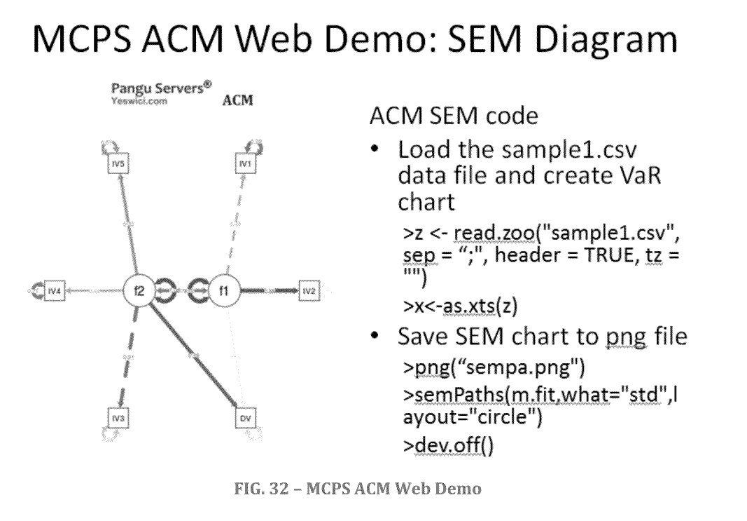

10. DeepCyber Value at Risk (VaR) smart cloud engines with Big Data analytics (see FIG. 18 and FIG. 23);

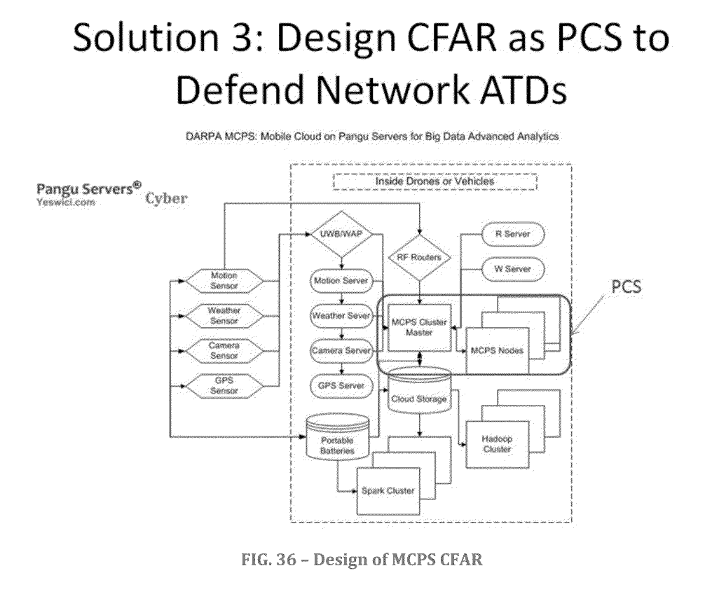

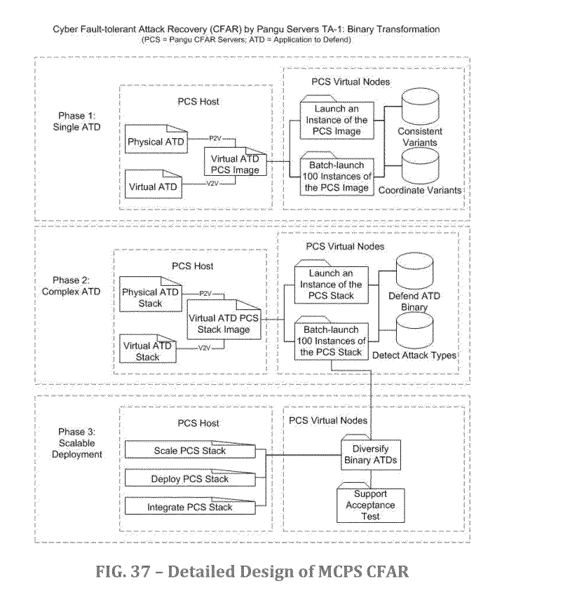

11. DeepCyber Cyber Fault-tolerant Attack Recovery (CFAR) engine with artificial-intelligence capabilities for zero-day cyber-attacks that are not signature-based (see FIG. 36);

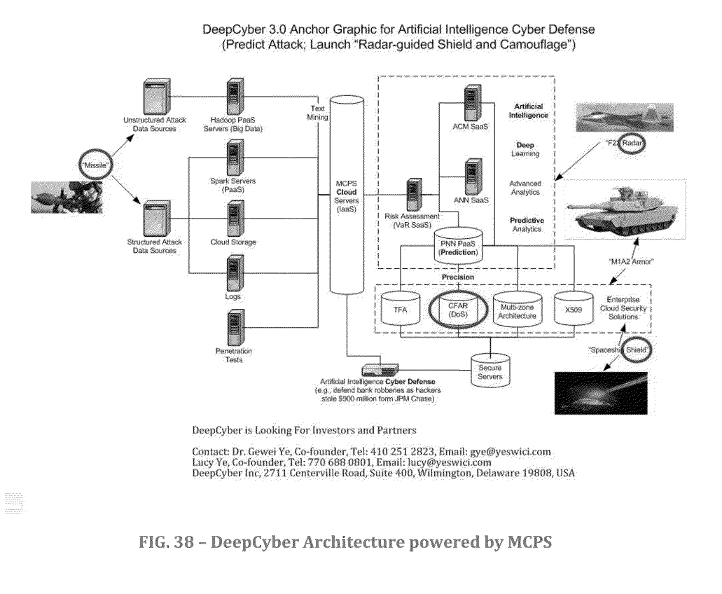

12. DeepCyber multi-zone (firewall) smart security architecture (MSA) to defend network intrusions (see FIG. 38);

13. DeepCyber solutions designed for U.S. Department of Defense DARPA (Defense Advanced Research Projects Agency)'s BAA (Broad Agency Announcement) specifications (DARPA-BAA-15-13 and DARPA-BAA-14-64) to defend the most sophisticated cyber-attacks in the world (see FIG. 12, 37);

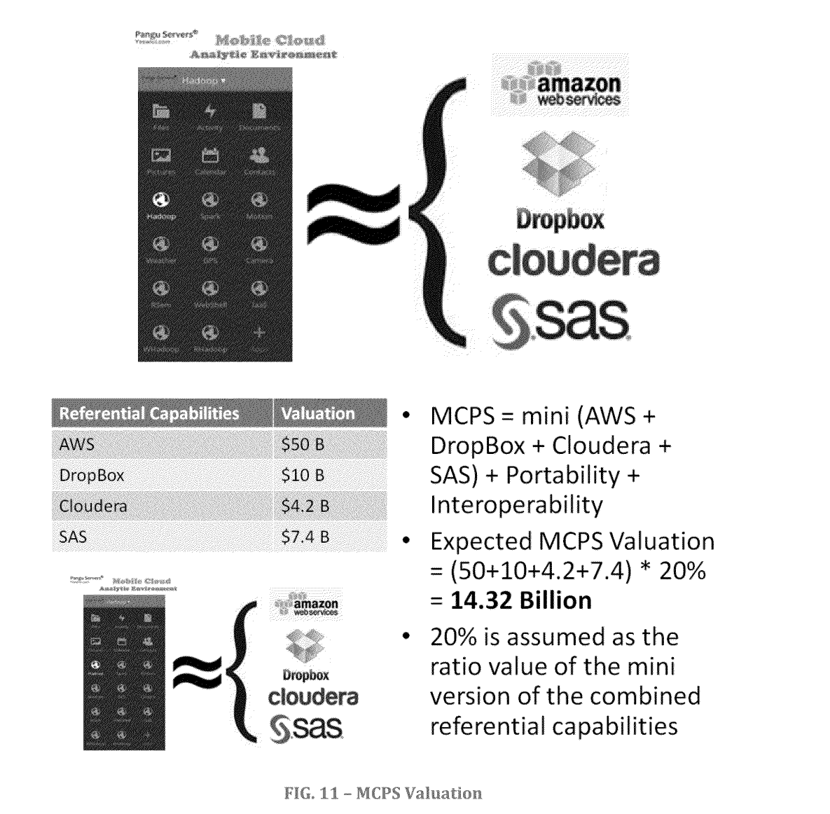

14. MCPS cloud: the integrated cloud-based platform of artificial intelligence and Big Data includes similar capabilities of combining AWS (Amazon Web Services), DropBox, Cloudera, and SAS (see FIG. 11);

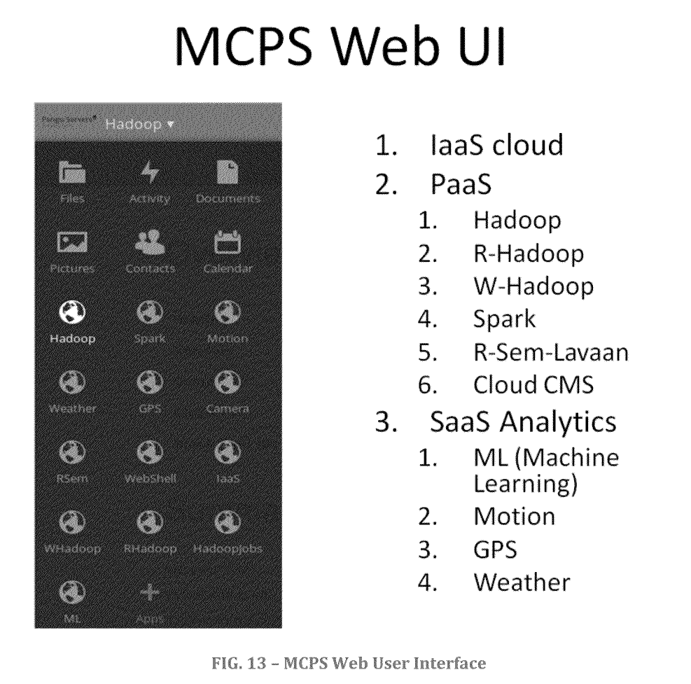

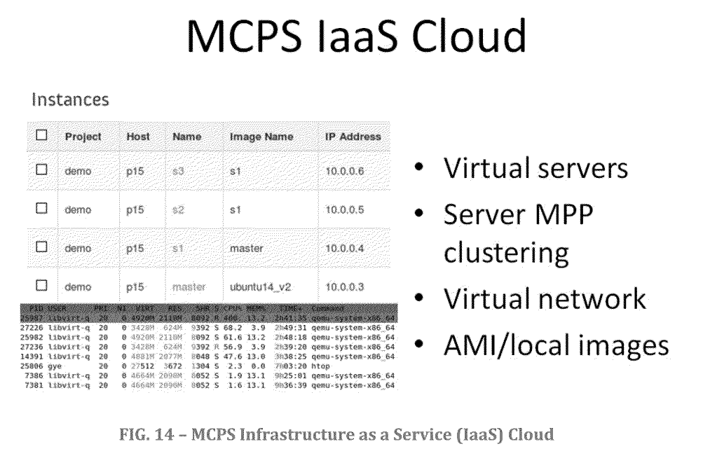

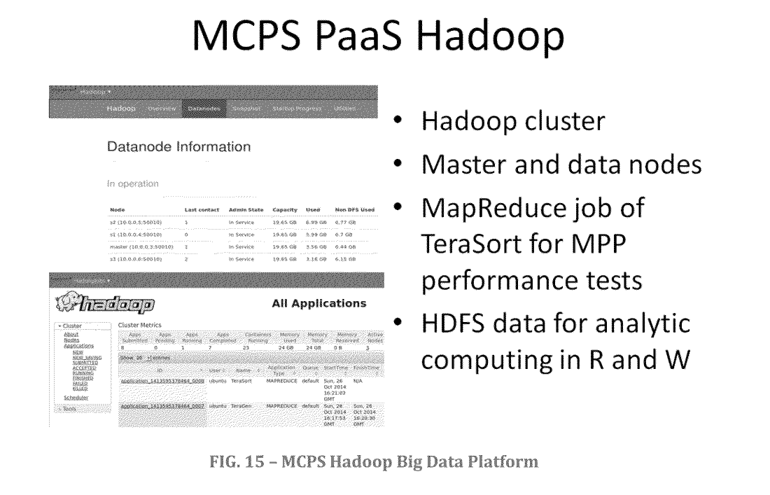

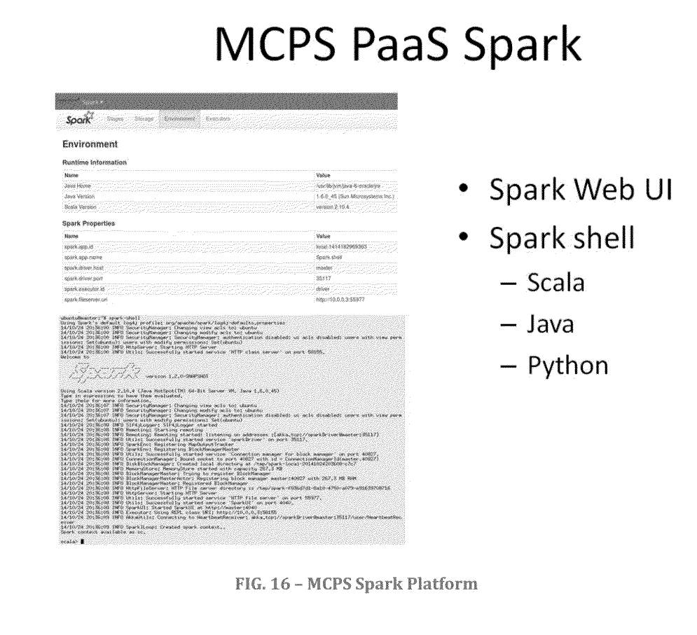

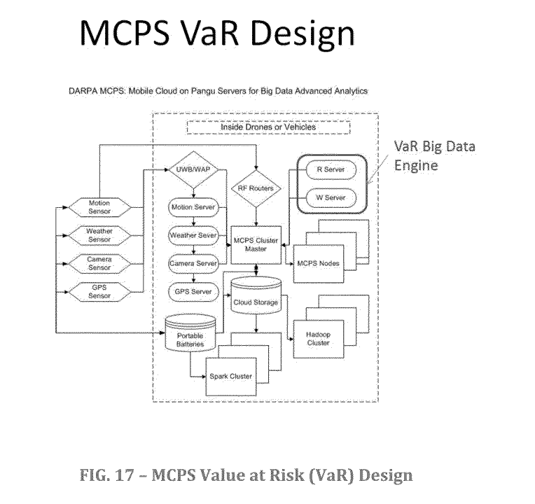

15. MCPS data center: a powerful, portable and interoperable platform for cyber defense (e.g., DeepCyber), financial predictions (e.g., PNN Financial), drones, data center, and Internet of Things (see FIG. 13, 14, 15, 16);

16. MCPS analytics: the unique game-changing portable cloud data center, originally designed for 18 DARPA specs including processing Big Data and artificial-intelligence workload of advanced analytics and artificial intelligence (see FIG. 12).

17. MCPS portable cloud platform: the first portable cloud data center initially designed for ground and aerial vehicles (see FIG. 11, 13, 16).
